(19) United States
(12) Patent Application Publication
(10) Pub. No.: US 2015/0128260 A1
(43) Pub. Date: May 7, 2015

(54) METHODS AND SYSTEMS FOR CONTROLLING COMMUNICATION IN A VIRTUALIZED NETWORK ENVIRONMENT

(71) Applicant: Zu QIANG, Kirkland (CA)

(72) Inventor: Zu QIANG, Kirkland (CA)

(73) Assignee: TELEFONAKTIEBOLAGET L M ERICSSON (PUBL), Stockholm (SE)

(21) Appl. No.: 14/535,164

(22) Filed: Nov. 6, 2014

Related U.S. Application Data
(60) Provisional application No. 61/900,884, filed on Nov. 6, 2013.

(51) Int. Cl. H04L 29/06; G06F 17/30

(52) U.S. Cl. CPC H04L 63/14; G06F 17/30103; G06F 17/30091
USPC 726/22

(57) ABSTRACT

Methods and related systems for controlling communication between Network Virtualization Edges (NVEs) in a network virtualization domain are provided. The methods generally involves generating and transmitting, by a Network Virtualization Authority (NVA), a list of participating NVEs to the NVEs comprised in the list, and the selective processing by the NVEs of messages received from other NVEs. By limiting NVE to NVE communication only to NVEs comprised in the list, attacks on the network can be mitigated.

### CROSS-REFERENCE TO RELATED APPLICATIONS

The present application claims the benefits of priority of U.S. Provisional Patent Application No. 61/900,884, entitled “Methods, Systems, Network Virtualization Edge (NVE) Nodes, and Network Virtualization Authority (NVA) Nodes for Improved Security in a Virtualized Environment”, and filed on Nov. 6, 2013, at the United States Patent and Trademark Office; the content of which is incorporated herein by reference.

### TECHNICAL FIELD

The present invention generally relates to the field of security in virtualized network environments, and more particularly in NVO3 virtualized network environments.

### BACKGROUND

The networking industry is working on a wide variety of network virtualization solutions. Multiple standardization organizations are involved in this effort, including OpenStack, the Open Network Forum (ONF), the Internet Engineering Task Force (IETF), etc.

One such network virtualization solution is to define an overlay virtual network over an underlay physical network. An overlay network is an approach for providing network virtualization services to a set of tenant systems (TSs). With an overlay network, data traffic between TSs is tunneled across the underlying physical network (e.g. a data center IP network). The use of tunnels provides a number of benefits by decoupling the network as viewed by the tenants from the underlying physical network across which they communicate. In an overlay network, TSs connect to virtual networks (VNs), with each VN having associated attributes defining properties of the network, such as the set of members that connect to it. TSs connected to a VN typically communicate freely with other TSs on the same VN, but communication between TSs on one VN and TSs external to the VN (whether on another VN or connected to the Internet) is typically carefully controlled and governed by policy.

In the field of overlay virtual networks, the IETF has proposed a network virtualization overlay framework generally referred to as the NVO3 framework. The NVO3 framework generally defines a Network Virtualization Domain (NVD) as an administrative construct that can support a set of VNs. To manage these VNs in the NVD, the NVO3 framework defines a Network Virtualization Authority (NVA) and Network Virtualization Edges (NVEs) associated with the NVA. The NVEs support communication for any of the VNs in the NVD. In a NVO3-based overlay network, a TS can be attached to a NVE, either locally (e.g. directly) or remotely (e.g. via an intermediate network).

In the NVO3 framework, the NVE is the network entity that implements the overlay functionality. In that sense, the NVE generally sits at the edge of the underlay network and implements layer 2 (L2) and/or layer 3 (L3) network virtualization functions (e.g. a L2 NVE can provide Ethernet LAN-like service, and a L3 NVE can provide IP/VRF-like service). The NVE typically comprises the network virtualization functions that allow for L2 and/or L3 tenant separation, and for hiding tenant addressing information (MAC and IP addresses), tenant-related control plane activity, and service contexts from the underlay network. The NVE may be used to provide different types of virtualized network services. The NVO3 framework generally allows IP encapsulation or MPLS encapsulation, where both L2 and L3 services can be supported.

The network-facing side of the NVE, i.e. the interface between the NVE and the other NVO3 network entities (e.g. NVEs, NVA, etc.) uses the underlying L3 network to tunnel data frames to and from other NVEs. The tenant-facing side of the NVE, i.e. the interface between the NVE and the hypervisor or the server, generally sends and receives Ethernet frames to and from individual TSs. Hence, the NVE generally resides at the boundary between a TS and the overlay network and generally creates and maintains local state about each VN for which it is providing service on behalf of a TS. A NVE may be implemented as part of a virtual switch within a hypervisor, a physical switch or router, a Network Service Appliance, or can even be split across multiple devices.

In the NVO3 framework, the NVA is the network entity that provides reachability and forwarding information to the NVEs. In that sense, a NVA is also known as a controller. Notably, though a NVO3-based network generally comprises several NVEs, it generally comprises only one NVA which is typically logically centralized.

In NVO3-based networks, both the hypervisor and the NVEs are typically at least partly implemented as pieces of software. Like any software, they are vulnerable to a local privilege escalation attack (e.g. attacks due to software errors or misconfigurations). The vulnerability may be exploited for local privilege escalation or a guest-to-host virtual machine escape. So both hypervisors and NVEs may be compromised due to any misconfigurations or software vulnerabilities. When the hypervisors and/or the NVEs are compromised by an attacker, the NVO3-based network and the underlay network architecture may be exposed to the attacker.

In that sense, when it is necessary to update peer NVEs inner-outer address mapping table, at VN connection/disconnection or at virtual network interface card (VNIC) association/dissociation for instance, all the existing solutions require that the NVE-NVE control plane packets be flooded, e.g. broadcast or multicast to all NVEs in the overlay network when no mapping exists (i.e. when the NVE does not know to whom to send the message). Such a flooding, however, may pose security risks to the NVE-NVE control plane.

For instance, a compromised network component (e.g. a compromised NVE) may try to initiate a denial of service (DoS) attack by flooding all NVEs with some incorrect network updating information. If the NVE-NVE control plane protocol requires responding, all the NVEs are exploited to act as reflectors of the attack, which only amplifies the problem. Understandably, when the number of involved NVEs is large enough, such as for example in a data center, the defective or compromised NVE may then broadcast to all other NVEs of the data center, which creates significant traffic problems, to the point of slowing down or even stalling the NVE-NVE control plane. Moreover, such an attack is very difficult to be detected and prevented if initiated from a compromised NVE.

Therefore, it would be desirable to provide methods and systems that obviate or mitigate the above described problems

### SUMMARY

It is an object of the present invention to obviate or mitigate at least one disadvantage of the prior art.

In accordance with one broad aspect of the present invention, there are provided methods and related systems for controlling communication between Network Virtualization Edges (NVEs) in a network virtualization domain in order to mitigate attacks (e.g. flooding attacks). The methods generally involve the generation and transmission by the Network Virtualization Authority (NVA) of one or more lists of participating NVEs. The lists are then used by participating NVEs to determine whether to process or discard messages received from other NVEs.

According to an exemplary embodiment, a method to control communication in a network virtualization domain generally comprises, at a NVA, generating a list of participating NVEs which generally comprises identification (e.g. an address) of each of the participating NVEs. The method further comprises transmitting the list of participating NVEs to each of the NVEs comprised in the list.

According to another exemplary embodiment, a method to control communication in a network virtualization domain generally comprises, at a NVE, receiving a list of participating NVEs, the list comprising identification (e.g. an address) of each of the participating NVEs. The method further comprises receiving a message from a sending NVE which may or may not be in the list of participating NVEs. The received message comprises identification (e.g. an address) of the sending NVE. Upon receiving the message, the method further comprises comparing the identification of the sending NVE with the identifications of the participating NVEs in the list of participating NVEs. As a function of the comparison, the method comprises either discarding the message if the identification of the sending NVE does not match any of the identifications of the participating NVEs in the list of participating NVEs (i.e. the sending NVE is not on the list of participating NVEs), or processing the message if the identification of the sending NVE matches at least one of the identifications of the participating NVEs in the list of participating NVEs (i.e. the sending NVE is on the list of participating NVEs).

According to another exemplary embodiment, a NVA adapted to perform methods to control communication in a network virtualization domain may comprise an input/output interface configured to communicate with external entities (e.g. NVEs), and an instruction repository (e.g. a memory) storing instructions that when executed by a processor cause the processor to determine participating NVEs, to generate a list of participating NVEs, the list comprising the identification (e.g. the address) of each participating NVE, and to cause the input/output interface to send or otherwise transmit the list of participating NVEs to each one of the participating NVEs, for allowing each participating NVE to be configured with the list of participating NVEs.

According to another exemplary embodiment, a NVA adapted to perform methods to control communication in a network virtualization domain may comprise a participating NVEs determining module responsible for determining participating NVEs, a list of participating NVEs generating module responsible for generating the list comprising the participating NVEs (and their identifications), and a list of participating NVEs transmitting module responsible for transmitting the generated list of participating NVEs to each of the NVEs comprised in the list.

According to another exemplary embodiment, a NVE adapted to perform methods to control communication in a network virtualization domain may comprise an input/output interface configured to receive a list comprising the identification (e.g. the address) of participating NVEs, a memory adapted to store the identifications of the participating NVEs, and an instruction repository storing instructions that when executed by a processor cause the processor to, upon the input/output interface receiving a message from a sending NVE, the message comprising an identification of the sending NVE, compare the identification of the sending NVE with the identifications of the participating NVEs in the list of participating NVEs, and as a function of the comparison, to discard the message if the identification of the sending NVE does not match any of the identifications of the participating NVEs in the list of participating NVEs, or to process the message if the identification of the sending NVE matches at least one of the identifications of the participating NVEs in the list of participating NVEs.

According to another exemplary embodiment, a NVE adapted to perform methods to control communication in a network virtualization domain may comprise a list of participating NVEs receiving module configured to receive the list of participating NVEs (from the NVA), a NVE message receiving module configured to receive messages from other NVEs, and a NVE message processing module configured to only process NVE messages received from NVEs comprised in the list of participating NVEs. In that sense, the NVE message processing module is generally further configured to discard any NVE messages received from NVEs not comprised in the list of participating NVEs.

In accordance with the principles of the present invention, by limiting NVE to NVE communication to the NVEs comprised in the list of participating NVEs, it becomes possible to effectively limit the impact of a security attack to a limited number of NVEs.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a network architecture diagram of an exemplary NVO3-based network;

FIG. 2 is a signaling and nodal operation diagram according to an exemplary embodiment of the invention;

FIG. 3 is a high level flowchart diagram of a method according to an exemplary embodiment of the invention as performed by a Network Virtualization Authority (NVA);

FIG. 4 is a high level flowchart diagram of a method according to an exemplary embodiment of the invention as performed by a Network Virtualization Edge (NVE);

FIG. 5 is a table of parameters comprised in an exemplary embodiment of the “Participating NVE List Query” message;

FIG. 6 is a table of parameters comprised in an exemplary embodiment of the “Participating NVE List Query Rejection” message;

FIG. 7 is a table of parameters comprised in an exemplary embodiment of the “Participating NVE List Query Configuration” message;

FIG. 8 is a table of parameters comprised in an exemplary embodiment of the “Participating NVE List Query Deletion” message;

FIG. 9 is a table of parameters comprised in an exemplary embodiment of the “Participating NVE List Confirmation” message;

FIG. 10 is a block diagram of a NVA according to an exemplary embodiment of the invention;

FIG. 11 is a block diagram of a NVA according to another exemplary embodiment of the invention;

FIG. 12 is a block diagram of a NVA according to another exemplary embodiment of the invention;

FIG. 13 is a block diagram of a NVE according to an exemplary embodiment of the invention;

FIG. 14 a block diagram of a NVE according to another exemplary embodiment of the invention;

FIG. 15 a block diagram of a NVE according to another exemplary embodiment of the invention.

### DETAILED DESCRIPTION

The present invention is generally directed to methods and related systems for controlling communication between Network Virtualization Edges (NVEs) in a NVO3 network architecture.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

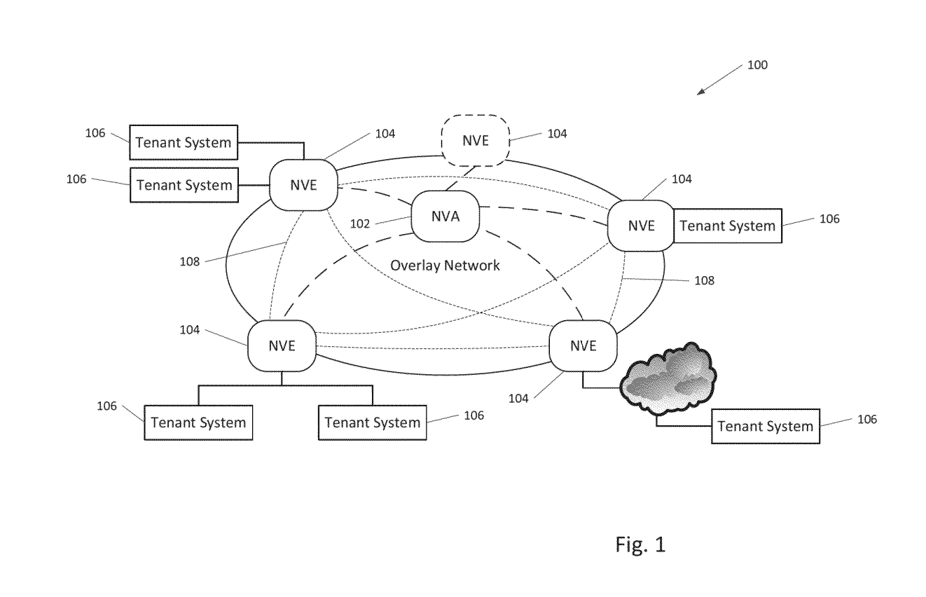

Referring first to FIG. 1, an exemplary NVO3-based network 100 is shown. The network 100 generally comprises a NVA 102, several NVEs 104, and several TSs 106 attached to the NVEs 104 either locally (e.g. directly) or remotely (e.g. via an intermediate network or network element). In the network 100, the NVA 102 is the network entity that provides reachability and forwarding information to the NVEs 104. In FIG. 1, the four NVEs 104 shown in solid lines are part of a VN 108.

Embodiments in accordance with the present invention generally provide security improvements in such a NVO3-based network 100 as they allow the NVA 102 to configure the NVEs 104 with one or more lists of participating NVEs (NVEs involved in the same VN communications, possibly including both data plane and control plane communications). This list of participating NVEs can be used to restrict the malicious flooding, that may be generated, for example, by the multiple broadcast messages and/or multicast messages sent out by attacked NVEs, only to the participating NVEs comprised in the list. By doing so, damages are limited to a smaller network area, i.e. to the VN in question and more particularly to the NVEs in the list. The impact of the security attack is thus reduced, affects fewer services, and/or has a lesser impact on the given service(s).

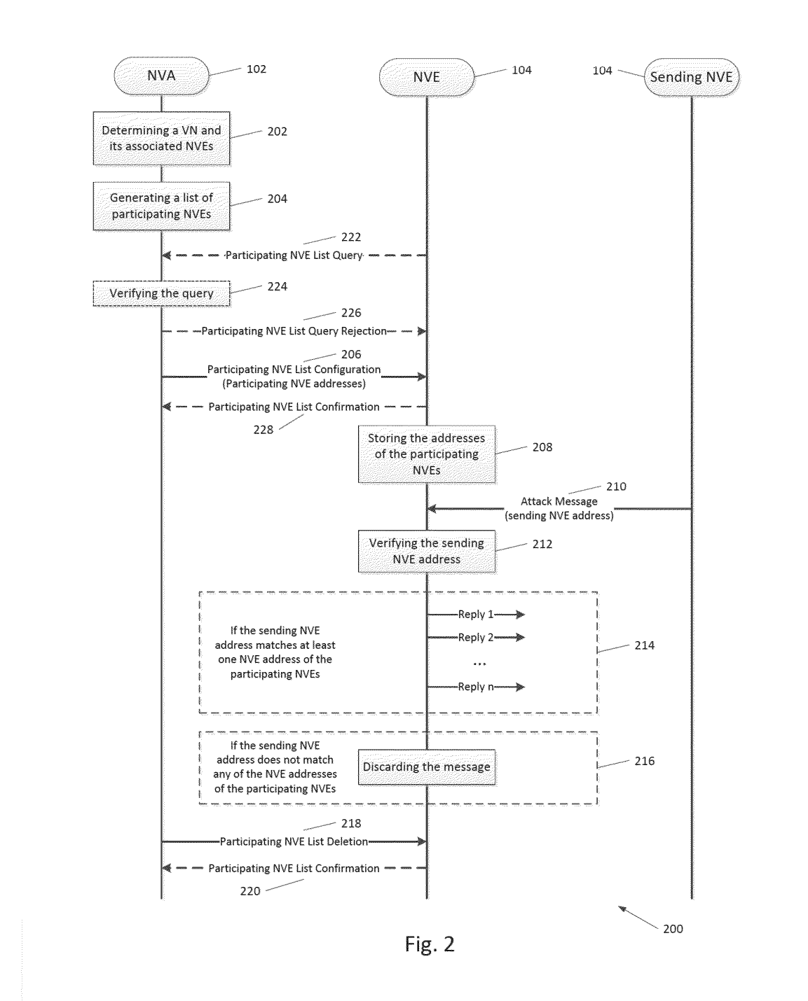

Referring now to FIG. 2, an exemplary signaling and nodal operation diagram 200 according to an embodiment of the present invention will now be described.

Starting at 202, the NVA 102 generally has, determines or otherwise acquires the knowledge (e.g. association information) of VNs (e.g. VN 108) and all their associated NVEs (e.g. the four NVEs 104). The NVA 102 may learn or otherwise determine this knowledge from a Virtual Machine Orchestration System if it is collocated therewith, or may determine it via a new Virtual Machine Orchestration Systems to NVA interface. Alternatively, the NVA 102 may determine this knowledge from the VN attachment notification received via the NVA-NVE interface as described in IETF draft-ietf-nvo3-nve-nva-cp-req, “Network Virtualization NVE to NVA Control Protocol Requirements”.

The NVA 102 then generates, at 204, a list of participating NVEs. In the present embodiment, a list can be generated for each connected VNs. In some embodiments, a list of participating NVEs can comprise all the NVEs associated with a given VN. In other embodiments, a list of participating NVEs can comprise a subset of all the NVEs associated with a given VN. In still other embodiments, the NVA 102 can generate multiple lists for a given VN. Notably, the list of participating NVEs may be defined with different granularity (e.g. on a per-VN basis, on a per-TS basis, etc.).

In the present embodiment, a security key can be assigned for each VN included in the list. This security key is typically different for each VN. If the security key is allocated, the NVE 104 may use it for NVE-NVE control plane encryption at control plane message sending. This can provide confidentiality, integrity and availability to the NVE-NVE control plane.

The NVA 102 then sends the list of participating NVEs to each one the participating NVEs as shown at 206. The list of participating NVEs generally comprises identifications of the participating NVEs (e.g. NVE addresses).

Once a participating NVE 104 receives the list, it typically stores, at 208, the NVE addresses comprised in the list.

Once the participating NVEs 104 are configured with the list of participating NVEs, the impact of a security attack on the overall network 100 is reduced. For example, a DoS attack 210 (or any other type of attack 210, may it originate inside or outside the NVE 104) may be made on the NVE 104. In the prior art, the NVE 104 would have acted as a reflector of the attack and would have sent reply messages to all connected NVEs 104 of the network 100.

According to present embodiment however, the NVE 104, which is configured with the list of participating NVEs, is configured to discard any message that is not addressed to, or does not relate to the NVEs 104 on the list of participating NVEs. Thus, if messages 214 (e.g. requests or replies, depending if the attacks originates inside or outside NVE 104) are to be sent, they will only be sent to the limited number of participating NVEs 104 on the list. In so doing, the present embodiment in accordance with the principles of the invention generally limits the impact of a security attack to a smaller network area, the area composed of the participating NVEs 104.

Again, if the NVE 104 receives a message 210 which is not addressed to, or does not relate to the NVEs 104 on the list of participating NVEs, the NVE 104 will simply discard the message, at 216, without further processing.

Understandably, VNs are dynamic in nature such that a VN can connect and disconnect as necessary. In that sense, at VN disconnection, the NVA 102 may remove the attached NVE 104 from the list of participating NVEs and update all the remaining participating NVEs via the NVA-NVE interface. In the present embodiment, when a NVE 104 is removed from the list of participating NVEs, it will receive a list deletion message as shown at 218 from the NVA 102. Upon receiving the list deletion message, the NVE 104 may send back a confirmation to the NVA 102, at 220, to indicate to the NVA 102 than the NVE 104 has properly received the message.

At VN connection, the NVE 104 can wait for the list of participating NVEs via the participating NVE list configuration message sent by NVA 102, as in 206. However, the NVE 104 can also send a query message to the NVA 102, at 222, actively asking for the list of participating NVEs. When a participating NVE list query request is received by the NVA 102 from a NVE 104, the NVA 102 may verify the request, at 224, before responding with the participating NVE list configuration message, at 206. If the verification fails however, the NVA 102 can reject the query and reply with a query rejection, at 226.

Once the NVE 104 receives the list of participating NVEs, via the participating NVE list configuration message, the NVE 104 may reply to the NVA 102 with a participating NVE list confirmation message, at 228, indicating to the NVA 102 than the NVE 104 has properly received the message.

In the present embodiment, a NVE 104 may not send any VN updating messages to any peer NVEs before the participating NVE list is configured. When VN updating is needed, the NVE 104 may use the list of participating NVEs when sending the VN updating messages to the peer NVEs. Understandably, the VN updating messages shall be sent to the participating NVEs 104 only.

When a virtual machine (VM) part of the VN 108 relocates to a new NVE 104 which is not in the list of participating NVE list of the VN 108, the NVA 102 will update the list of participating NVEs for that VN 108 and will further update all the participating NVEs, through the NVA-NVE interface, by transmitting the updated list to all the participating NVEs 104.

In the event that a VN is completely disconnected from a data center, the NVA 102 may update all the participating NVEs associated with the now-disconnected VN via the NVA-NVE interface. In such case, the NVA 102 may send participating list deletion messages (e.g. message 218 in FIG. 2) to all the participating NVEs associated with the now-disconnected VN. In turn, the NVEs 104 may reply with confirmation messages (e.g. message 220 in FIG. 2) confirming the deletion of the list from the NVEs.

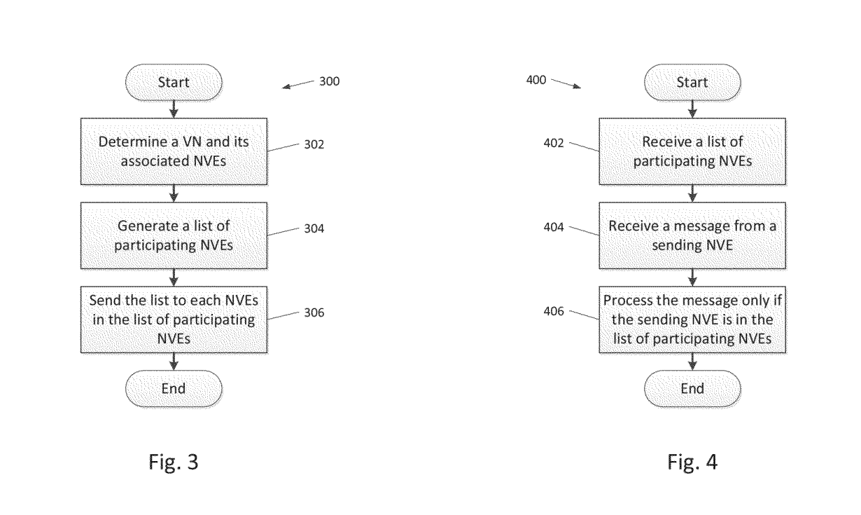

An embodiment of a method in accordance with the present invention as implemented by a NVA 102 can be further illustrated by the flow chart 300 depicted in FIG. 3. According to the flowchart 300, the method generally starts with the NVA 102 determining a VN and its associated NVEs 104. Then the NVA 102 generates a list of participating NVEs, the list comprising the identification (e.g. the address) of each participating NVE. Thereafter, the NVA 102 sends or otherwise transmits the list with the addresses of the participating NVEs to each one of the participating NVEs. This allows each participating NVE 104 to be configured with the list of participating NVEs and to only communicate with NVEs 104 from the list, in order, for instance, to mitigate the impact of a security attack by limiting communications of the NVE to the pool of participating NVEs.

An embodiment of a method in accordance with the present invention as implemented by a NVE 104 can be further illustrated by the flow chart 400 depicted in FIG. 4. According to the flowchart 400, the method generally starts with the NVE 104 receiving a list comprising the identifications (e.g. the addresses) of participating NVEs 104 and storing the list in a memory of the NVE 104. This list allows the NVE 104 to be configured so as to only communicate with other NVEs 104 on the list. In that sense, following the reception of a message from a sending NVE 104, the NVE 104 processes the message only if the sending NVE is on the list of participating NVEs (i.e. the address of the sending NVE matches at least one address in the list of participating NVEs). Otherwise, the NVE 104 discards the message. This contributes to mitigating the impact of a security attack by limiting communications between NVEs 104 to the pool of participating NVEs.

In that regard, in the present embodiment, a NVE 104 will send a broadcast control plane message only to peer NVEs 104 in the network 100 which are on the list of participating NVEs. Similarly, if a NVE 104 receives a broadcast control plane message sent by a NVE 104 which is not on the list of participating NVEs, it must discard it without processing. In that sense, NVEs 104 may have ingress filter control on the NVE-NVE control plane traffic to properly filter NVE-NVE control plane messages received from other NVEs.

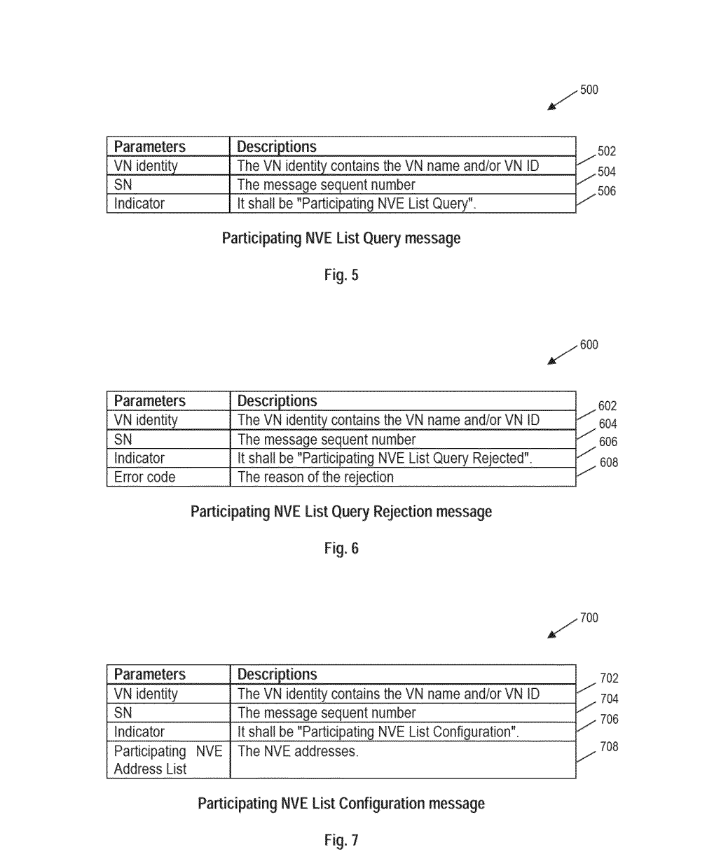

Referring now to FIGS. 5 to 9, examples of messages that can be exchanged between the NVA 102 and the NVEs 104 are illustrated. Notably, the illustrated messages only list the relevant parameters which may be contained in such messages. Additional and/or alternative parameters may be included if needed, and the nature and format of the messages may vary.

FIG. 5 illustrates a Participating NVE List Query message 500. This is the message sent by the NVE 104 to the NVA 102 when the NVE 104 queries the NVA 104 to receive the list of participating NVEs. The Participating NVE List Query message 500 generally comprises the identity of the VN 502 (e.g. VN name and/or VN ID) to which the NVE is associated, the message sequent number 504, and a message indicator 506 (e.g. “Participating NVE List Query”).

FIG. 6 illustrates a Participating NVE List Query Rejection message 600. This is the message sent by the NVA 102 to the NVE 104 if a participating NVE list query is rejected by the NVA 102. Notably, if the query is accepted, the NVA 102 may simply respond by transmitting the Participating NVE List Configuration message 700 described below.

The Participating NVE List Query Rejection message 600 generally comprises the identity of the VN 602 (e.g. VN name and/or VN ID) to which the NVE is associated, the message sequent number 604, a message indicator 606 (e.g. “Participating NVE List Query Rejected”). The message 600 can also comprise an error code 608 comprising at least one reason for the rejection.

FIG. 7 illustrates a Participating NVE List Configuration message 700. This is the message sent by the NVA 102 to the NVE 104 for a participating NVE list configuration.

The Participating NVE List Configuration message 700 generally comprises the identity of the VN 702 (e.g. VN name and/or VN ID) to which the NVE is associated, the message sequent number 704, a message indicator 706 (e.g. “Participating NVE List Configuration”), and a list of the address of each participating NVE 104.

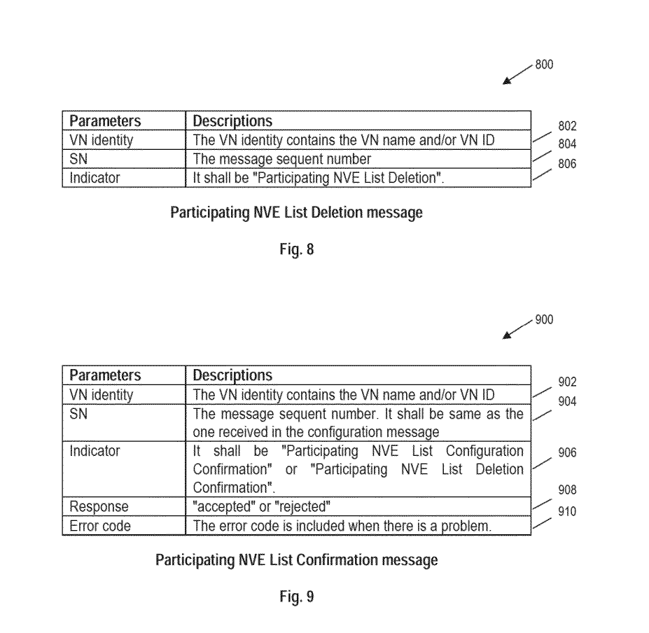

FIG. 8 illustrates a Participating NVE List Deletion message 800. This is the message sent by the NVA 102 to the NVE 104 for a list of participating NVEs deletion.

The Participating NVE List Deletion message 800 generally comprises the identity of the VN 802 (e.g. VN name and/or VN ID) to which the NVE is associated, the message sequent number 804, and a message indicator 806 (e.g. “Participating NVE List Deletion”).

FIG. 9 illustrates a Participating NVE List Confirmation message 900. This is the message sent by the NVE 104 to the NVA 102 to confirm that the participating NVE list configuration or deletion is either accepted or rejected.

The Participating NVE List Configuration message 900 generally comprises the identity of the VN 902 (e.g. VN name and/or VN ID) to which the NVE is associated, the message sequent number 904, a message indicator 906 (e.g. “Participating NVE List Configuration Confirmation” or “Participating NVE List Deletion Confirmation”), a response 908 (e.g. “accepted” or “rejected”), and an error code 910 (e.g. a reason for the error if any). Notably, the sequent number 904 used in the Participating NVE List Confirmation message should be the same as the one received in the Participating NVE List Configuration (sequent number 704) or Deletion message (sequent number 804).

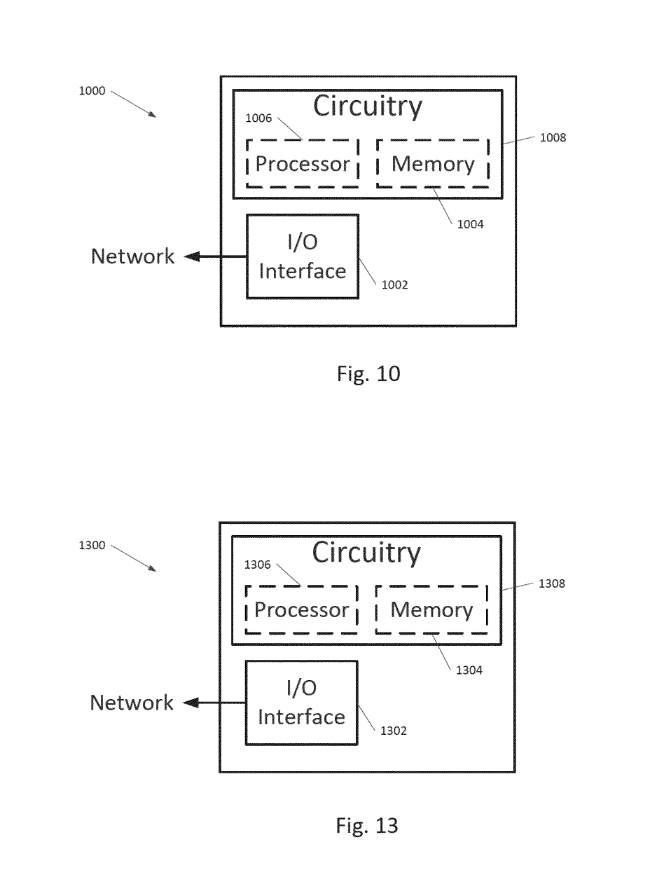

Referring now to FIGS. 10 to 12, methods to control communication between NVEs 104 in a NVO3 network 100 may be performed by a NVA 102 comprising various combinations of components or modules.

Hence, referring to FIG. 10, an embodiment 1000 of a NVA 102 is illustrated as generally comprising an input/output interface 1002 configured to communicate with external entities (e.g. NVEs 104), and an instruction repository 1004 (e.g. a memory) storing instructions that when executed by a processor 1006 cause the processor 1006 to determine a VN 108 and its associated NVEs 104, to generate a list of participating NVEs, the list comprising the identification (e.g. the address) of each participating NVE 104, and to cause the input/output interface 1002 to send or otherwise transmit the list of participating NVEs to each one of the participating NVEs 104. This allows each participating NVE 104 to be configured with the list of participating NVEs. Once configured, the NVEs 104 can only communicate with other NVEs 104 from the list. Limiting communication between NVEs comprised in the list of the participating NVEs can mitigate the impact of a security attack by limiting damages to the pool of participating NVEs 104.

In the present embodiment, the processor 1006 may be comprised in the NVA 102. In other embodiments, the memory 1004 and processor 1006 can be embodied as functional modules in circuitry 1008.

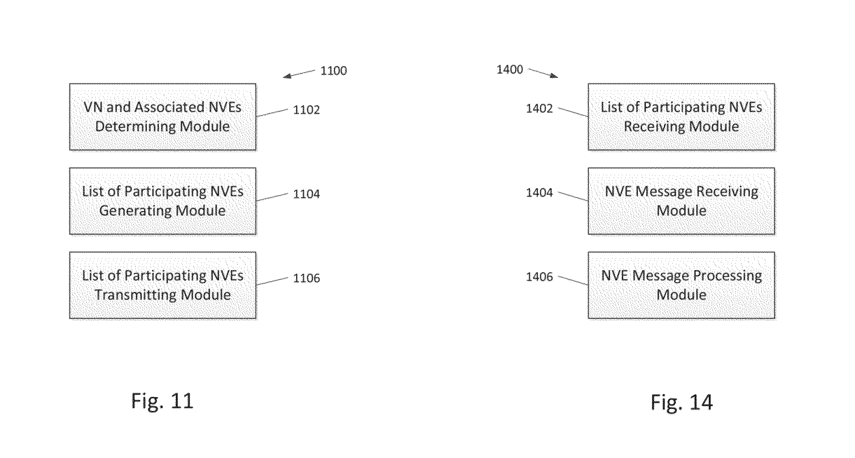

In FIG. 11, another embodiment of a NVA 102 is illustrated as comprising a group 1100 of modules.

Group 1100 of modules generally comprises a VN and associated NVEs determining module 1102 responsible for determining a VN 108 and its associated NVEs 104, a list of participating NVEs generating module responsible for generating the list of participating NVEs 104 and their identification (e.g. their address), and a list of participating NVEs transmitting module responsible for transmitting the generated list of participating NVEs to each of the NVEs 104 comprised in the list.

In other embodiments, the group 1100 could comprise additional modules configured to perform additional functions.

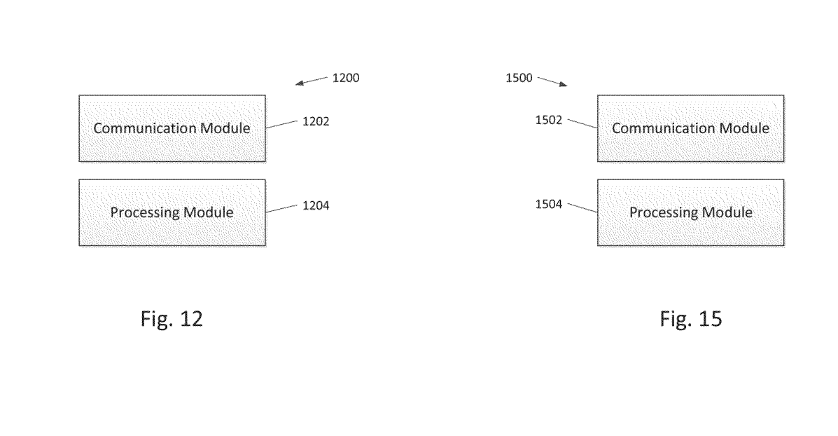

In FIG. 12, yet another embodiment of a NVA 102 is illustrated. In FIG. 12, the NVA 102 is depicted as comprising a group 1200 of modules comprising a communication module 1202 configured to communicate with external entities (e.g. NVEs 104), and a processing module 1204 for determining a VN 108 and its associated NVEs 104, and for generating a list of participating NVEs, the list comprising the identification (e.g. the address) of each participating NVE 104. The communication module 1202 is further configured to send or otherwise transmit the list with the identification of the participating NVEs 104 to each one of the participating NVEs 104.

In other embodiments, the NVA 102 could comprise means for communicating with external entities (e.g. NVEs 104), means for determining a VN 108 and its associated NVEs 104, means for generating a list of participating NVEs, the list comprising the identification (e.g. the address) of each participating NVE 104, and means for sending the list with the identification of the participating NVEs to each one of the participating NVEs 104. Such means may be implemented using processors, memories, ASIC modules, and the likes, or may be implemented partially or totally in software.

Referring now to FIGS. 13 to 15, methods to control communication between NVEs 104 in a NVO3 network 100 may be performed by a NVE 104 comprising various combinations of components or modules.

Referring to FIG. 13, an embodiment 1300 of a NVE 104 is illustrated as generally comprising an input/output interface 1302 configured to receive a list comprising identifications (e.g. addresses) of participating NVEs 104, a memory 1304 adapted to store the identifications of the participating NVEs 104, and an instruction repository (e.g. memory 1304) storing instructions that when executed by a processor 1306 cause the processor 1306 to configure the NVE 104 such that when the NVE 104 receives a message for another NVE 104, e.g. a sending NVE 104, the NVE 104 only communicates or otherwise processes the message if the sending NVE 104 is on the list. By limiting communication between NVEs 104 comprised in the list of the participating NVEs, the impact of a security attack can be mitigated by limiting damages to the pool of participating NVEs 104.

In the present embodiment, the processor 1306 may be comprised in the NVE 104. In other embodiments, the memory 1304 and processor 1306 can be embodied as functional modules in circuitry 1308.

In FIG. 14, another embodiment of a NVE 104 is illustrated as comprising a group 1400 of modules.

Group 1400 of modules generally comprises a list of participating NVEs receiving module 1402 responsible for receiving the list of participating NVEs from the NVA 102, a NVE message receiving module 1404 configured to receive messages from other NVEs 104, and a NVE message processing module 1406 configured to only process NVE messages received from NVEs 104 comprised in the list of participating NVEs. In that sense, the NVE message processing module is generally further configured to discard any NVE messages received from NVEs 104 not comprised in the list of participating NVEs.

In other embodiments, the group 1400 could comprise additional modules configured to perform additional functions.

In FIG. 15, yet another embodiment of a NVE 104 is illustrated. In FIG. 15, the NVE 104 is depicted as comprising a group 1500 of modules generally comprising a communication module 1502 for receiving a list comprising identifications (e.g. addresses) of participating NVEs 104, and a processing module 1504 for configuring the NVE 104 so that the NVE 104 only communicates with the other NVEs 104 on the list.

In other embodiments, the NVE 104 could comprise means for receiving a list comprising identifications (e.g. addresses) of participating NVEs 104, means for storing the identifications of the participating NVEs 104, and means for configuring the NVE 104 such that the NVE 104 only communicates with other NVEs 104 on the list. Such means may be implemented using processors, memories, ASIC modules, and the likes, or may be implemented partially or totally in software.

In yet other embodiments, the NVA 102 and the NVEs 104 could form a system.

By limiting NVE to NVE communications to NVEs 104 comprised in a list of participating NVEs, it becomes possible to effectively limit the impact of a security attack on one or more NVEs to only the participating NVEs 104 on the list.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method to control communication in a network virtualization domain, the method comprising, at a network virtualization authority (NVA):
determining a virtual network (VN) in the network virtualization domain and network virtualization edges (NVEs) associated with the VN;
generating a list of participating NVEs, the list comprising an identification of each of the participating NVEs;
transmitting the list of participating NVEs to each of the NVEs comprised in the list.

2. A method as claimed in claim 1, wherein the participating NVEs are a subset of the NVEs associated with the VN.

3. A method as claimed in claim 1, wherein the list of participating NVEs is transmitted via a list configuration message.

4. A method as claimed in claim 1, further comprising:
receiving a query from a NVE to receive the list of participating NVEs;
wherein the transmitting of the list of participating NVEs is performed in response to receiving the query.

5. A method as claimed in claim 4, further comprising:
verifying the query;
wherein the transmitting of the list of participating NVEs is further performed upon accepting the query.

6. A method as claimed in claim 1, further comprising:
responsive to at least one NVE associated with the VN disconnecting from the VN, generating a new list of participating NVEs;
transmitting the new list of participating NVEs to each of the NVEs comprised in the new list.

7. A method as claimed in claim 1, further comprising:
responsive to at least one new NVE connecting with the VN, generating a new list of participating NVEs;
transmitting the new list of participating NVEs to each of the NVEs comprised in the new list.

8. A method to control communication in a network virtualization domain, the method comprising, at a network virtualization edge (NVE):
receiving a list of participating NVEs, the list comprising an identification of each of the participating NVEs;
receiving a message from a sending NVE, the message comprising an identification of the sending NVE;
comparing the identification of the sending NVE with the identifications of the participating NVEs in the list of participating NVEs;
as a function of the comparison, discarding the message if the identification of the sending NVE does not match any of the identifications of the participating NVEs in the list of participating NVEs, or processing the message if the identification of the sending NVE matches at least one of the identifications of the participating NVEs in the list of participating NVEs.

9. A method as claimed in claim 8, further comprising:
transmitting a query to a network virtualization authority (NVA) to receive the list of participating NVEs.

10. A method as claimed in claim 8, further comprising:
transmitting a confirmation to a network virtualization authority (NVA) responsive to receiving the list of participating NVEs.

11. A method as claimed in claim 8, further comprising:
storing the identifications of the participating NVEs comprised in the list of participating NVEs.

12. A network virtualization authority (NVA) in a virtual network domain, the NVA comprising:
an input/output interface;
an instruction repository storing instructions;
a processor which upon executing instructions stored in the instruction repository, is adapted to:
determine a virtual network (VN) and network virtualization edges (NVEs) associated with the VN;
generate a list of participating NVEs comprising an identification of each of the participating NVEs; and
cause the input/output interface to transmit the list of participating NVEs to each one of the participating NVEs.

13. A network virtualization authority (NVA) as claimed in claim 12, wherein the participating NVEs are a subset of the NVEs associated with the VN.

14. A network virtualization authority (NVA) as claimed in claim 12, wherein the processor is further adapted to:
receive a query from a NVE to receive the list of participating NVEs;
wherein the transmitting of the list of participating NVEs is performed in response to receiving the query.

15. A network virtualization authority (NVA) as claimed in claim 14, wherein the processor is further adapted to:
verify the query;
wherein the transmitting of the list of participating NVEs is further performed upon accepting the query.

16. A network virtualization authority (NVA) as claimed in claim 12, wherein the processor is further adapted to:
responsive to at least one NVE associated with the VN disconnecting from the VN, generate a new list of participating NVEs;
cause the input/output interface to transmit the new list of participating NVEs to each of the NVEs comprised in the new list.

17. A network virtualization authority (NVA) as claimed in claim 12, wherein the processor is further adapted to:
responsive to at least one new NVE connecting with the VN, generate a new list of participating NVEs;
cause the input/output interface to transmit the new list of participating NVEs to each of the NVEs comprised in the new list.

18. A network virtualization edge (NVE) in a virtual network domain, the NVE comprising:
an input/output interface;
an instruction repository storing instructions;
a processor which upon executing instructions stored in the instruction repository, is adapted to:
receive a list of participating NVEs, the list of participating NVEs comprising an identification of each of the participating NVEs;
receive a message from a sending NVE, the message comprising an identification of the sending NVE;
compare the identification of the sending NVE with the identifications of the participating NVEs in the list of participating NVEs;
as a function of the comparison, discard the message if the identification of the sending NVE does not match any of the identifications of the participating NVEs in the list of participating NVEs, or process the message if the identification of the sending NVE matches at least one of the identifications of the participating NVEs in the list of participating NVEs.

19. A network virtualization edge (NVE) as claimed in claim 18, wherein the processor is further adapted to:
cause the input/output interface to transmit a query to a network virtualization authority (NVA) to receive the list of participating NVEs.

20. A network virtualization edge (NVE) as claimed in claim 18, wherein the processor is further adapted to:
cause the input/output interface to transmit a confirmation to a network virtualization authority (NVA) responsive to receiving the list of participating NVEs.

21. A network virtualization edge (NVE) as claimed in claim 18, wherein the processor is further adapted to:
store the identifications of the participating NVEs comprised in the list of participating NVEs.

22. A network virtualization authority (NVA) in a virtual network domain, the NVA comprising:
a VN and associated network virtualization edge (NVEs) determining module configured for determining a virtual network (VN) and the NVEs associated with the VN;
a list of participating NVEs generating module configured for generating a list of participating NVEs and their identification; and
a list of participating NVEs transmitting module configured for transmitting the generated list of participating NVEs to each of the NVEs comprised in the list.

23. A network virtualization authority (NVA) in a virtual network domain, the NVA comprising:
a processing module adapted to determine a virtual network (VN) and network virtualization edges (NVEs) associated with the VN, and to generate a list of participating NVEs, the list of participating NVEs comprising an identification of each of the participating NVEs;
a communication module adapted to transmit the list of participating NVEs to each one of the participating NVEs.

24. A network virtualization edge (NVE) in a virtual network domain, the NVE comprising:
a list of participating NVEs receiving module configured for receiving a list of participating NVEs;
a NVE message receiving module configured for receiving messages from NVEs; and
a NVE message processing module configured for only processing NVE messages received from NVEs comprised in the list of participating NVEs.

25. A network virtualization edge (NVE) in a virtual network domain, the NVE comprising:
a communication module configured for receiving a list of participating NVEs; and
a processing module for configuring the NVE to only communicate with NVEs comprised in the list.
